(19) United States
(12) Patent Application Publication
(10) Pub. No.: US 2017/0278354 A1
(43) Pub. Date: Sep. 28, 2017

(54) CASINO BASED CARD GAME OF SUIT RACES

(71) Applicant: Scott William Bird, Alliston (CA)

(72) Inventor: Scott William Bird, Alliston (CA)

(21) Appl. No.: 15/083,212

(22) Filed: Mar. 28, 2016

(51) Int. Cl. G07F 17/32; A63F 1/00

(52) U.S. Cl. CPC G07F 17/3295; A63F 1/00; G07F 17/3276; G07F 17/3211

(57) ABSTRACT

A method of operating a card game, comprising the steps of providing a betting surface, comprising: a first marked area for placing one or more bets that 15 cards will appear before 5 cards of a same suit are drawn.

### FIELD OF THE INVENTION

The present disclosure is in the field of card based casino games.

### BACKGROUND OF THE DISCLOSURE

Casino card games are provided in two main formats with card games in which combinations of cards are ranked (e.g., poker-type games) and games in which values of cards are counted (e.g., blackjack and baccarat-type games). There are also some games that have combined these two types of play, as by using hands or combinations of hands from a blackjack game to form poker hands.

There is a need for an improved fast paced casino based card game with a variety of betting odds.

### SUMMARY OF THE INVENTION

Disclosed herein is a method of operating a card game, comprising the steps of a) providing a betting surface, comprising: a first marked area for placing one or more bets that 15 cards will appear before 5 cards of a same suit are drawn; a second marked area for placing bets that a color of a suit of 5 cards will be red; a third marked area for placing bets that a color of a suit of 5 cards will be black; a fourth marked area for placing bets that a suit of 5 cards will be spades; a fifth marked area for placing bets that a suit of 5 cards will be clubs; a sixth marked area for placing bets that a suit of 5 cards will be hearts; a seventh marked area for placing bets that a suit of 5 cards will be diamonds; an eighth marked area for placing bets that a last card drawn of any winning suit is an odd numbered card; a ninth marked area for placing bets that a last card drawn of any winning suit is an even numbered card; and a tenth marked area for placing bets that a last card drawn of any winning suit is a face card or an ace. b) permitting the players to place bets in the first marked area, second marked area, third marked area, fourth marked area, fifth marked are, sixth marked area, seventh marked area, eighth marked area, ninth marked area and tenth marked area; c) providing 15 successively dealt single cards unless a suit of 5 cards are dealt; d) collecting and paying the bets placed in the first marked area, second marked area, third marked area, fourth marked area, fifth marked are, sixth marked area, seventh marked area, eighth marked area, ninth marked area and tenth marked area; e) permitting one or more players to place new bets in the first marked area, second marked area, third marked area, fourth marked area, fifth marked are, sixth marked area, seventh marked area, eighth marked area, ninth marked area and tenth marked area; and f) repeating steps (c) to (e) the dealer collecting and paying the bets placed in the permitting the players to place bets in the first marked area, second marked area, third marked area, fourth marked area, fifth marked are, sixth marked area, seventh marked area, eighth marked area, ninth marked area and tenth marked area.

In another aspect, disclosed herein is a kit for operating a card game, comprising: a) a betting surface, comprising: a first marked area for placing one or more bets that 15 cards will appear before 5 cards of a same suit are drawn; a second marked area for placing bets that a color of a suit of 5 cards will be red; a third marked area for placing bets that a color of a suit of 5 cards will be black; a fourth marked area for placing bets that a suit of 5 cards will be spades; a fifth marked area for placing bets that a suit of 5 cards will be clubs; a sixth marked area for placing bets that a suit of 5 cards will be hearts; a seventh marked area for placing bets that a suit of 5 cards will be diamonds; an eighth marked area for placing bets that a last card drawn of any winning suit is an odd numbered card; a ninth marked area for placing bets that a last card drawn of any winning suit is an even numbered card; and a tenth marked area for placing bets that a last card drawn of any winning suit is a face card or an ace; b) a playing area comprising four columns wherein each column corresponds to each suit of cards including spades, clubs, hearts and diamonds with five rows each and a finish line portion between row 4 and row 5; and c) a standard 2 color 52 card deck of playing cards.

### BRIEF DESCRIPTION OF THE DRAWINGS

FIG. 1 is an illustration of an embodiment of a betting board of the card based casino game disclosed herein.

FIG. 2 is an illustration of an embodiment of a betting board of the card based casino game disclosed herein.

FIG. 3 is an illustration of a playing area of the card based casino game disclosed herein.

FIG. 4A is an illustration of a crazy eight side bet playing area of the card based casino game disclosed herein.

FIG. 4B is an illustration of a Ladies First side bet playing area of the card based casino game disclosed herein.

FIG. 5 illustrates a schematic block diagram of a conceptual computer system 500 used to implement some embodiments. For example, the card based casino game described with reference to the disclosure and Figures herein may be at least partially implemented using computer system 500.

### DETAILED DESCRIPTION OF THE EMBODIMENTS

The following is a detailed description of certain specific embodiments of the card based casino game disclosed herein. In this description reference is made to the drawings.

In one aspect, disclosed herein is a method of operating a card game, comprising the steps of a) providing a betting surface, comprising: a first marked area for placing one or more bets that 15 cards will appear before 5 cards of a same suit are drawn; a second marked area for placing bets that a color of a suit of 5 cards will be red; a third marked area for placing bets that a color of a suit of 5 cards will be black; a fourth marked area for placing bets that a suit of 5 cards will be spades; a fifth marked area for placing bets that a suit of 5 cards will be clubs; a sixth marked area for placing bets that a suit of 5 cards will be hearts; a seventh marked area for placing bets that a suit of 5 cards will be diamonds; an eighth marked area for placing bets that a last card drawn of any winning suit is an odd numbered card; a ninth marked area for placing bets that a last card drawn of any winning suit is an even numbered card; and a tenth marked area for placing bets that a last card drawn of any winning suit is a face card or an ace; b) permitting the players to place bets in the first marked area, second marked area, third marked area, fourth marked area, fifth marked are, sixth marked area, seventh marked area, eighth marked area, ninth marked area and tenth marked area; c) providing 15 successively dealt single cards unless a suit of 5 cards are dealt; d) collecting and paying the bets placed in the first marked area, second marked area, third marked area, fourth marked area, fifth marked are, sixth marked area, seventh marked area, eighth marked area, ninth marked area and tenth marked area; e) permitting one or more players to place new bets in the first marked area, second marked area, third marked area, fourth marked area, fifth marked are, sixth marked area, seventh marked area, eighth marked area, ninth marked area and tenth marked area; and f) repeating steps (c) to (e) the dealer collecting and paying the bets placed in the permitting the players to place bets in the first marked area, second marked area, third marked area, fourth marked area, fifth marked are, sixth marked area, seventh marked area, eighth marked area, ninth marked area and tenth marked area, wherein the method of operating the card game further comprises a playing area comprising four columns wherein each column corresponds to each suit of cards including spades, clubs, hearts and diamonds with five rows each and a finish line portion between row 4 and row 5.

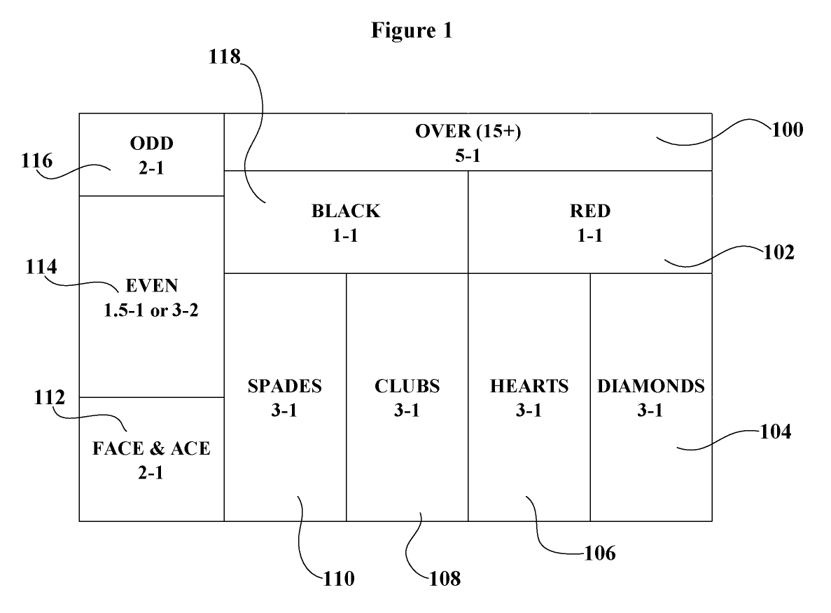

Turning to the drawings, FIG. 1 depicts a betting board of the card based casino game disclosed herein. The betting board of FIG. 1 comprises a first marked area for placing one or more bets that 15 cards will appear before 5 cards of a same suit are drawn 100 with odds of 5-1, a second marked area for placing bets that a color of a suit of 5 cards will be red 102 with odds of 1-1, a third marked area for placing bets that a color of a suit of 5 cards will be black 118 with odds of 1-1, a fourth marked area for placing bets that a suit of 5 cards will be spades 110 with odds of 3-1, a fifth marked area for placing bets that a suit of 5 cards will be clubs 108 with odds of 3-1, a sixth marked area for placing bets that a suit of 5 cards will be hearts 106 with odds of 3-1, a seventh marked area for placing bets that a suit of 5 cards will be diamonds 104 with odds of 3-1, an eighth marked area for placing bets that a last card drawn of any winning suit is an odd numbered card 116 with odds of 2-1, a ninth marked area for placing bets that a last card drawn of any winning suit is an even numbered card 114 with odds of 1.5-1 or 3-2, and a tenth marked area for placing bets that a last card drawn of any winning suit is a face card or an ace 112 with odds of 2-1. In some embodiments, the 5 cards of a same suit are all red cards or all black cards. In some embodiments, the suit of 5 cards is a suit of spades, a suit of clubs, a suit of hearts or a suit of diamonds.

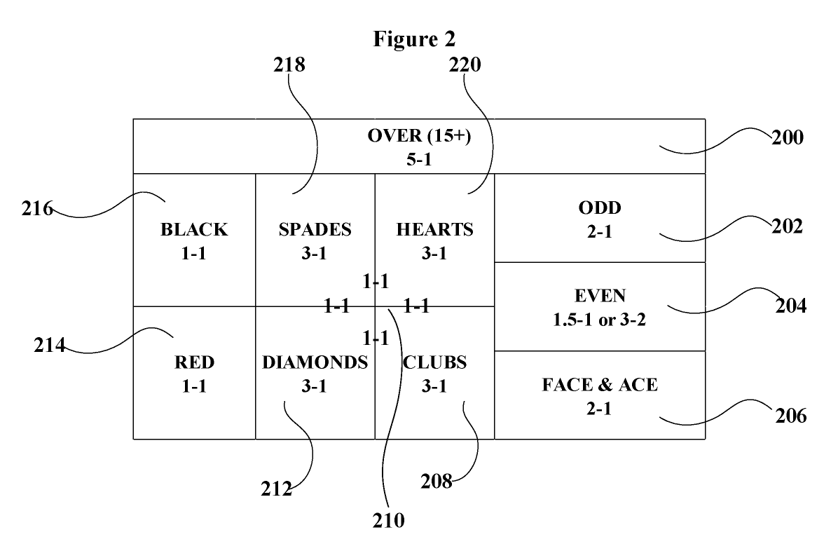

In another aspect, FIG. 2 depicts a betting board of the card based casino game disclosed herein. The betting board of FIG. 1 comprises a first marked area for placing one or more bets that 15 cards will appear before 5 cards of a same suit are drawn 200 with odds of 5-1, a second marked area for placing bets that a color of a suit of 5 cards will be red 214 with odds of 1-1, a third marked area for placing bets that a color of a suit of 5 cards will be black 216 with odds of 1-1, a fourth marked area for placing bets that a suit of 5 cards will be spades 218 with odds of 3-1, a fifth marked area for placing bets that a suit of 5 cards will be clubs 208 with odds of 3-1, a sixth marked area for placing bets that a suit of 5 cards will be hearts 220 with odds of 3-1, a seventh marked area for placing bets that a suit of 5 cards will be diamonds 212 with odds of 3-1, an eighth marked area for placing bets that a last card drawn of any winning suit is an odd numbered card 202 with odds of 2-1, a ninth marked area for placing bets that a last card drawn of any winning suit is an even numbered card 204 with odds of 1.5-1 or 3-2, and a tenth marked area for placing bets that a last card drawn of any winning suit is a face card or an ace 206 with odds of 2-1. In some embodiments, the betting board of FIG. 2 comprises betting areas along dividing lines 210 between the different suits with odds of 1-1. In some embodiments, the method of operating a card game further comprises that bets may be placed on a dividing line between the fourth marked area for placing bets that a suit of 5 cards will be spades, the fifth marked area for placing bets that a suit of 5 cards will be clubs, the sixth marked area for placing bets that a suit of 5 cards will be hearts, and/or the seventh marked area for placing bets that a suit of 5 cards will be diamonds.

The casino style game disclosed herein may operate with a permanent bank. Moreover, players may bet against the dealer or the house. As discussed, the object for the players of the game is to bet on which suit will appear 5 times first. Additional ways for players to win include but are not limited to betting the color of the winning suit (i.e., Red or Black), betting on the last card to be played (i.e., odd, even or a face card), and betting if 15 cards will appear on the playing area before 5 of the same suit are drawn. In this aspect, the betting odds are determined by the risk and probability of them appearing, which are displayed in the betting boards of FIG. 1 or 2.

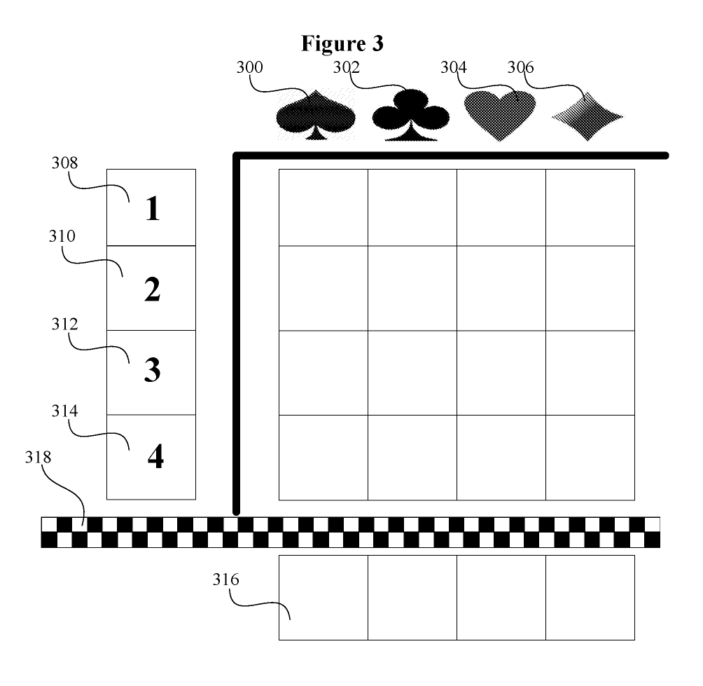

The number of players that can bet against the house is unlimited or as many as the betting card table can accommodate. In this aspect, each player will be assigned an individual color of chips to bet with to ensure that no player will exceed a four bet maximum per run, as well as guarantee no confusion upon bets being paid out. The card game disclosed herein may use a standard 2 color 52 card deck and one plastic colored blank card used for cutting the deck before a deal. In some embodiments, the cards comprise a standard 2 color 52 playing cards. There are two different parts of the playing table to include but not limited to the betting board of FIG. 1 or 2 and the playing area of FIG. 3.

The minimum and maximum bet will be determined by the casino or house for the card game disclosed herein. Each player may purchase chips from the dealer or house. The chips may be color coordinated to each individual player to insure there is no confusion regarding which bet belongs to each player. In some embodiments, the method of operating a card game further comprises that each player uses betting chips of a different color.

Moreover, this game gives you the option to bet on the color of the suit (Red or Black) that will have the first 5 to appear or the actual suit (Spades, Clubs, Hearts or Diamonds). Players may also bet on which type of card is going to appear last in the run (i.e., odd number, even number, or a face card/ace). Players may also bet that 15 cards will appear (i.e., “Over” (15+)) before 5 of the same suit appear and cross the finish line (318) depicted as a row of winning card 5 (316) as shown with FIG. 3 with a suit. If an Over 15+ is dealt, all other bets on the betting board lose, minus the side bets “Crazy 8” and “Ladies First”.

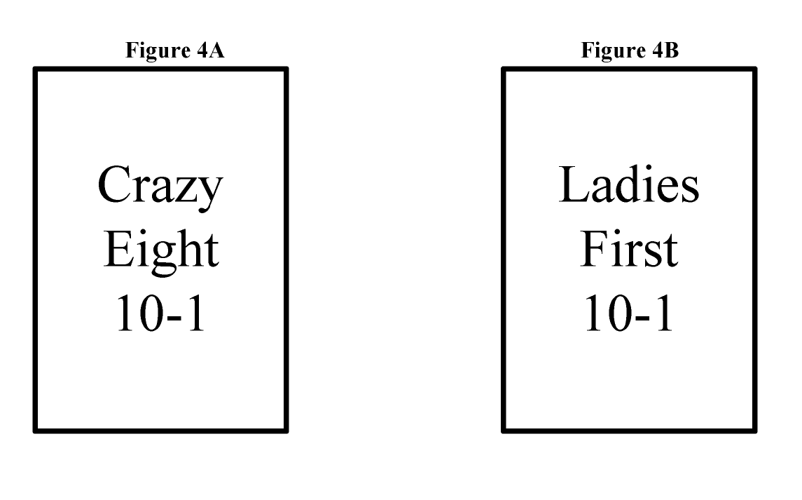

Depending on the casino, house or table there may be side bets. An example of a side bet is if the last card of the 15 card run is an 8 (i.e., Crazy 8, giving 10-1 odds). FIG. 4A is an illustration of a crazy eight side bet playing area of the card based casino game disclosed herein. Another example of a side bet may be on what card will appear first (i.e., Ladies First, giving 10-1 odds). FIG. 4B is an illustration of a Ladies First side bet playing area of the card based casino game disclosed herein. In some embodiments, the method of operating a card game further comprises that the one or more players may place a crazy eight side bet that a last card dealt is an 8 card. In some embodiments, the method of operating a card game further comprises that the one or more players may place a Ladies First side bet that a last card dealt is a queen card.

The betting odds and probabilities as shown in Table 1 were derived from a form of a hypergeometric distribution, involving more than one variable. The probability of drawing fifteen cards and not getting five of any one suit is the probability of getting a 4-4-4-3 fit within slots of the playing board of FIG. 3. In this aspect, the Over occurs 9.3% of the time, which correlates to 5 cards of any suit appearing 90.7% of the time in a run of 15 cards dealt.

TABLE 1
(Betting Odds and Mathematical Probabilities)

| Outcome | Probability | Betting Odds |
|---|---|---|
| Over | 9.3% | 5-1 |
| Red | 45.35% | 1-1 |
| Black | 45.35% | 1-1 |
| Hearts | 22.675% | 3-1 |
| Diamonds | 22.675% | 3-1 |
| Spades | 22.675% | 3-1 |
| Clubs | 22.675% | 3-1 |
| Odd | 27.84% | 2-1 |
| Even | 34.82% | 1.5-1 or 3-2 |
| Face & Ace | 27.84% | 2-1 |
| Ladies First | 7.69% | 10-1 |
| Crazy 8 | 7.69% | 10-1 |

By comparison, 200 mock runs of 15 cards were analyzed for wins and the following Winning percentages were tabulated in Table 2 and compared to the corresponding calculated probabilities.

TABLE 2
(Mathematical Probabilities Derived from 200 Mock-Hands)

| | # of wins out | | Statistical |
|---|---|---|---|
| Winning Outcome | of 200 | Winning % | Probability |
| Over (15+) | 30 | 15% | 9.3% |
| Red | 90 | 45% | 45.35% |
| Black | 80 | 40% | 45.35% |
| Diamond | 42 | 21% | 22.675% |
| Heart | 48 | 24% | 22.675% |
| Spade | 44 | 22% | 22.675% |
| Club | 36 | 18% | 22.675% |
| Face & Ace | 48 | 24% | 27.84% |
| Odd | 53 | 26.5% | 27.84% |
| Even | 69 | 34.5% | 34.82% |

With regard to dealing and shuffling it is preferred that a single deck be used, which is shuffled after a maximum of 15 cards are dealt. Alternatively, the shoe could be a multiple deck continuous shuffling type. Before each hand or run is dealt the dealer will shuffle a single deck and ask one of the players to “cut the deck”, as needed. Using the colored plastic card, the player will randomly position the card into the deck. Then, the dealer will separate the deck into two stacks, thereby making the colored card the new bottom of the deck. The dealer will then stack the other stack on top, thereby making the card that was previously below the cut as the new top card, and place the deck in the dealer shoe. As soon as the dealer has positioned the deck in the deal shoe the dealer will motion a hand over top of the betting area, thereby signally that there are no more bets for this run.

Turning to the drawings, FIG. 3 is an illustration of a playing area of the card based casino game disclosed herein. As depicted, FIG. 3 comprises 4 columns corresponding to each suit (i.e., spades, clubs, hearts and diamonds), with 5 rows corresponding to card 1 (308), card 2 (310), card 3 (312), card 4 (314), finish line (318) and winning card 5 (316).

The dealer will then reveal each card at a time and place it into the column of the corresponding suit with the playing area depicted in FIG. 3. The projected run 15 cards drawn is over when 5 cards of the same suit are revealed and cross the finish line 318 or 15 cards are in the playing area without crossing the finish line 318. Upon the completion of the dealer will mark the winning/deciding card and winning slots on the betting board. The dealer will then collect all losing bets and proceed to pay out the winning bets. Finally, no winnings shall be collected by a player until all bets on the board are paid out. An exception would be a winning bet for the Ladies First, which would be paid out immediately.

In another aspect, disclosed herein is a kit for operating a card game, comprising a) a betting surface, comprising: a first marked area for placing one or more bets that 15 cards will appear before 5 cards of a same suit are drawn; a second marked area for placing bets that a color of a suit of 5 cards will be red; a third marked area for placing bets that a color of a suit of 5 cards will be black; a fourth marked area for placing bets that a suit of 5 cards will be spades; a fifth marked area for placing bets that a suit of 5 cards will be clubs; a sixth marked area for placing bets that a suit of 5 cards will be hearts; a seventh marked area for placing bets that a suit of 5 cards will be diamonds; an eighth marked area for placing bets that a last card drawn of any winning suit is an odd numbered card; a ninth marked area for placing bets that a last card drawn of any winning suit is an even numbered card; and a tenth marked area for placing bets that a last card drawn of any winning suit is a face card or an ace; b) a playing area comprising four columns wherein each column corresponds to each suit of cards including spades, clubs, hearts and diamonds with five rows each and a finish line portion between row 4 and row 5; and c) a standard 2 color 52 card deck of playing cards. In some embodiments, the kit for operating a card game further comprises betting chips for each player of a different color. In some embodiments, the game is wholly or partially presented via a computer system. In some embodiments, the kit for operating a card game further comprises that the game is wholly or partially presented via a computer system.

### Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be adapted to perform functions and/or features that may be associated with various software elements described throughout.

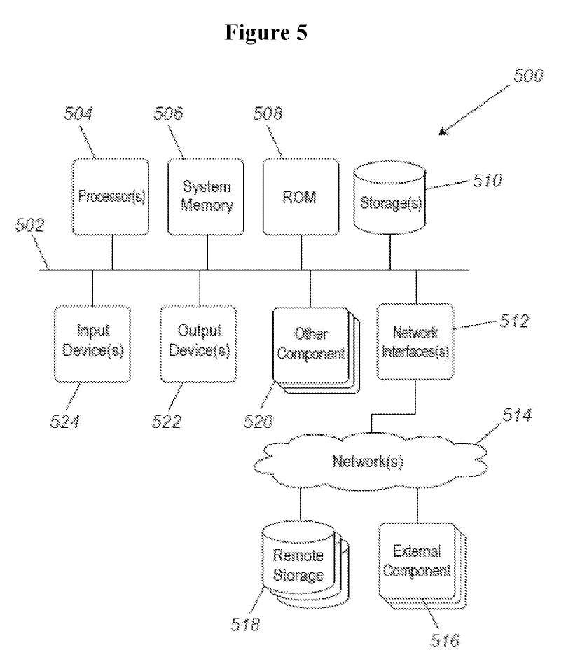

Referring to the drawings, FIG. 5 illustrates a schematic block diagram of a conceptual computer system 500 used to implement some embodiments. For example, the system described above in reference to FIGS. 1-4 may be at least partially implemented using all or a portion of computer system 500.

Computer system 500 may be implemented using various appropriate devices. For instance, the computer system may be implemented using one or more vehicle display units, personal computers (PCs), servers, mobile devices (e.g., a smartphone), tablet devices, and/or any other appropriate devices. The various devices may work alone (e.g., the computer system may be implemented as a vehicle display unit) or in conjunction (e.g., some components of the computer system may be provided by a vehicle display unit while other components may be provided by a tablet device).

As shown, computer system 500 may include at least one communication bus 502, one or more processors 504, a system memory 506, a read-only memory (ROM) 508, permanent storage devices 510, input devices 524, output devices 522, various other components 520 (e.g., a graphics processing unit), and one or more network interfaces 512 and may include a network 514, corresponding remote storage 518 and a corresponding external component 516.

Bus represents all communication pathways among the elements of computer system 500. Such pathways may include wired, wireless, optical, and/or other appropriate communication pathways. For example, input devices 524 and/or output devices 522 may be coupled to the system 500 using a wireless connection protocol or system.

The processor 504 may, in order to execute the processes of some embodiments, retrieve instructions to execute and/or data to process from components such as system memory 506, ROM 508, and permanent storage device 510. Such instructions and data may be passed over bus 502.

System memory 506 may be a volatile read-and-write memory, such as a random access memory (RAM). The system memory may store some of the instructions and data that the processor uses at runtime. The sets of instructions and/or data used to implement some embodiments may be stored in the system memory 506, the permanent storage device 510, and/or the read-only memory 508. ROM 508 may store static data and instructions that may be used by processor 504 and/or other elements of the computer system.

Permanent storage device 510 may be a read-and-write memory device. The permanent storage device may be a non-volatile memory unit that stores instructions and data even when computer system 500 is off or unpowered. Computer system 500 may use a removable storage device and/or a remote storage device as the permanent storage device.

Input devices 524 may enable a user to communicate information to the computer system and/or manipulate various operations of the system. The input devices may include keyboards, cursor control devices, audio input devices and/or video input devices. Output devices 522 may include printers, displays, and/or audio devices. Some or all of the input and/or output devices may be wirelessly or optically connected to the computer system.

Other components 520 may perform various other functions. These functions may include performing specific functions (e.g., graphics processing, sound processing, etc.), providing storage, interfacing with external systems or components, etc.

Referring to FIG. 5, computer system 500 may be coupled to one or more networks 514 through one or more network interfaces 512. For example, computer system 500 may be coupled to a web server on the Internet such that a web browser executing on computer system 500 may interact with the web server as a user interacts with an interface that operates in the web browser. Computer system 500 may be able to access one or more remote storages 518 and one or more external components 516 through the network interface 512 and network 514. The network interface(s) 512 may include one or more application programming interfaces (APIs) that may allow the computer system 500 to access remote systems and/or storages and also may allow remote systems and/or storages to access computer system 500 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 500 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

### Definitions

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and devices within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or devices, which can of course vary. It is also to be understood that the terminology used herein is for the purpose of describing particular embodiments only, and is not intended to be limiting.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

What is claimed is:

1. A method of operating a card game, comprising the steps of:
a) providing a betting surface, comprising: a first marked area for placing one or more bets that 15 cards will appear before 5 cards of a same suit are drawn; a second marked area for placing bets that a color of a suit of 5 cards will be red; a third marked area for placing bets that a color of a suit of 5 cards will be black; a fourth marked area for placing bets that a suit of 5 cards will be spades; a fifth marked area for placing bets that a suit of 5 cards will be clubs; a sixth marked area for placing bets that a suit of 5 cards will be hearts; a seventh marked area for placing bets that a suit of 5 cards will be diamonds; an eighth marked area for placing bets that a last card drawn of any winning suit is an odd numbered card; a ninth marked area for placing bets that a last card drawn of any winning suit is an even numbered card; and a tenth marked area for placing bets that a last card drawn of any winning suit is a face card or an ace;
b) permitting the players to place bets in the first marked area, second marked area, third marked area, fourth marked area, fifth marked are, sixth marked area, seventh marked area, eighth marked area, ninth marked area and tenth marked area;
c) providing 15 successively dealt single cards unless a suit of 5 cards are dealt;
d) collecting and paying the bets placed in the first marked area, second marked area, third marked area, fourth marked area, fifth marked are, sixth marked area, seventh marked area, eighth marked area, ninth marked area and tenth marked area;
e) permitting one or more players to place new bets in the first marked area, second marked area, third marked area, fourth marked area, fifth marked are, sixth marked area, seventh marked area, eighth marked area, ninth marked area and tenth marked area; and
f) repeating steps (c) to (e) the dealer collecting and paying the bets placed in the permitting the players to place bets in the first marked area, second marked area, third marked area, fourth marked area, fifth marked are, sixth marked area, seventh marked area, eighth marked area, ninth marked area and tenth marked area.

2. The method of claim 1, wherein the game is wholly or partially presented via a computer system.

3. The method of claim 1, wherein the 5 cards of a same suit are all red cards or all black cards.

4. The method of claim 1, wherein the suit of 5 cards is a suit of spades, a suit of clubs, a suit of hearts or a suit of diamonds.

5. The method of claim 1, further comprising that bets may be placed on a dividing line between the fourth marked area for placing bets that a suit of 5 cards will be spades, the fifth marked area for placing bets that a suit of 5 cards will be clubs, the sixth marked area for placing bets that a suit of 5 cards will be hearts, and/or the seventh marked area for placing bets that a suit of 5 cards will be diamonds.

6. The method of claim 1, further comprising that the one or more players may place a crazy eight side bet that a last card dealt is an 8 card.

7. The method of claim 1, further comprising that the one or more players may place a Ladies First side bet that a last card dealt is a queen card.

8. The method of claim 1, wherein the cards comprise a standard 2 color 52 card deck of playing cards.

9. The method of claim 1, further comprising that each player uses betting chips of a different color.

10. The method of claim 1, further comprising a playing area comprising four columns wherein each column corresponds to each suit of cards including spades, clubs, hearts and diamonds with five rows each and a finish line portion between row 4 and row 5.

11. A kit for operating a card game, comprising a betting surface, comprising: a first marked area for placing one or more bets that 15 cards will appear before 5 cards of a same suit are drawn; a second marked area for placing bets that a color of a suit of 5 cards will be red; a third marked area for placing bets that a color of a suit of 5 cards will be black; a fourth marked area for placing bets that a suit of 5 cards will be spades; a fifth marked area for placing bets that a suit of 5 cards will be clubs; a sixth marked area for placing bets that a suit of 5 cards will be hearts; a seventh marked area for placing bets that a suit of 5 cards will be diamonds; an eighth marked area for placing bets that a last card drawn of any winning suit is an odd numbered card; a ninth marked area for placing bets that a last card drawn of any winning suit is an even numbered card; and a tenth marked area for placing bets that a last card drawn of any winning suit is a face card or an ace.

12. The kit according to claims 11, further comprising betting chips for each player of a different color.

13. The kit according to claims 11, further comprising that the game is wholly or partially presented via a computer system.

14. A kit for operating a card game, comprising:
a) a betting surface, comprising: a first marked area for placing one or more bets that 15 cards will appear before 5 cards of a same suit are drawn; a second marked area for placing bets that a color of a suit of 5 cards will be red; a third marked area for placing bets that a color of a suit of 5 cards will be black; a fourth marked area for placing bets that a suit of 5 cards will be spades; a fifth marked area for placing bets that a suit of 5 cards will be clubs; a sixth marked area for placing bets that a suit of 5 cards will be hearts; a seventh marked area for placing bets that a suit of 5 cards will be diamonds; an eighth marked area for placing bets that a last card drawn of any winning suit is an odd numbered card; a ninth marked area for placing bets that a last card drawn of any winning suit is an even numbered card; and a tenth marked area for placing bets that a last card drawn of any winning suit is a face card or an ace;
b) a playing area comprising four columns wherein each column corresponds to each suit of cards including spades, clubs, hearts and diamonds with five rows each and a finish line portion between row 4 and row 5; and
c) a standard 2 color 52 card deck of playing cards.

15. The kit according to claims 14, further comprising betting chips for each player of a different color.

16. The kit according to claims 14, further comprising that the game is wholly or partially presented via a computer system.
